(19) United States
(12) Patent Application Publication
(10) Pub. No.: US 2007/0167201 A1
(43) Pub. Date: Jul. 19, 2007

(54) Gaming Machines Having Multi-Functional Icons and Related Methods

(75) Inventor: David B. Schultz, Henderson, NV (US)

Correspondence Address: STEPTOE & JOHNSON, LLP, 1330 CONNECTICUT AVENUE, NW, WASHINGTON, DC, 20036, US

(73) Assignee: Bally Gaming International, Inc., Las Vegas, NV (US)

(21) Appl. No.: 11/307,024

(22) Filed: Jan. 19, 2006

(51) Int. Cl. A63F 13/00

(52) U.S. Cl. 463/1

(57) ABSTRACT

Gaming machines having multi-functional icons are disclosed herein. The gaming machine includes a game display for displaying one or more games. The gaming machine also includes a game processor for managing one or more games displayed on the game display where at least one game includes a multi-functional icon that comprises a plurality of selectable game functions. The gaming machine also includes a means for selecting the game function of a multi-functional icon, wherein the selection means is in communication with the game processor.

Embodiments disclosed herein generally relate to gaming machines having multi-functional icons.

### BACKGROUND

Many types of gaming machines have been developed with various features to captivate and maintain player interest. Generally, maintaining player interest in a gaming machine is based upon providing the player with many opportunities to win money. For example, in some slot machines, the display windows show more than one adjacent symbol on each reel, thereby allowing for multiple-row betting. Other types of slot machines have been developed that offer “second chance” or bonus games that provide players with additional opportunities to win. These “second chance” games generally include “bonus symbols” that trigger a bonus game. Other games include “wild” symbols that may be used to form a winning outcome. While these games have been successful, there is need for additional gaming machines that provide a player with enhanced excitement and diversity of game play without departing from the original gaming concept.

### SUMMARY

Briefly, and in general terms, various embodiments directed to gaming machines and/or gaming systems having a multi-functional icon are disclosed herein. In one embodiment, the gaming machine includes a game display for displaying one or more games. The gaming machine also includes a game processor for managing one or more games displayed on the game display where at least one game includes a multi-functional icon that comprises a plurality of selectable game functions. The gaming machine also includes a means for selecting the game function of a multi-functional icon, wherein the selection means is in communication with the game processor.

Another embodiment is directed to gaming systems. The gaming system comprises at least one gaming machine comprising a game display and a game processor providing one or more games where at least one game includes a multi-functional icon comprising a plurality of selectable game functions. The gaming system also includes a system host in communication with the gaming machines where the system host monitors the gaming machines. The gaming system also includes a player tracking system in communication the game machines.

In addition to gaming machines and gaming systems, various methods of managing a game having a multi-functional icon are disclosed herein. According to one method, a gaming machine having a multi-functional icon is provided, wherein the multi-functional icon comprises one or more game functions. The gaming machine receives player input selecting one or more functions for the multi-functional icon, and then sets the function of the multi-functional icon. A gaming session is then initiated and a game outcome is generated and displayed on the gaming machine. In another method, the game outcome is analyzed for the multi-functional icon, and the gaming machine ascertains whether the selected function of the multi-functional icon produces a winning outcome.

In another method, a function of multi-functional icon is selected, and the selected function of the multi-functional icon is displayed on a display screen. A gaming session is initiated and a game outcome is generated. The game outcome is then displayed on the display screen. The game outcome is analyzed for the multi-functional icon, and the gaming machine ascertains whether the selected function of the multi-functional icon produces a winning outcome. According to one method, a player selects the function of the multi-functional icon. In another method, a game processor selects the function of the multi-functional icon.

These and other features and advantages will become apparent from the following detailed description, taken in conjunction with the accompanying drawings, which illustrate by way of example, the features of the various embodiments.

### BRIEF DESCRIPTION OF THE DRAWINGS

FIG. 1 is a perspective of one embodiment of a gaming machine for use with a multi-functional icon.

FIG. 2 is a front view of one embodiment of a display for use with an embodiment of a multi-functional icon.

FIG. 3 is a schematic illustration of a casino gaming system for use in accordance with an embodiment of a multi-function icon.

### DETAILED DESCRIPTION

Various embodiments disclosed herein are directed to one or more multi-functional icons for use with a plurality of gaming machines and gaming systems. More particularly, a multi-functional icon is an icon that has a plurality of selectable functions. That is, the multi-functional icon may act as a wild symbol, a multiplier symbol, a bonus game triggering symbol, or the like. The function of the icon may be selected by a player or randomly selected by the gaming machine. Accordingly, players can choose the type of game or customize their gaming experience by selecting a function for the multi-functional icon.

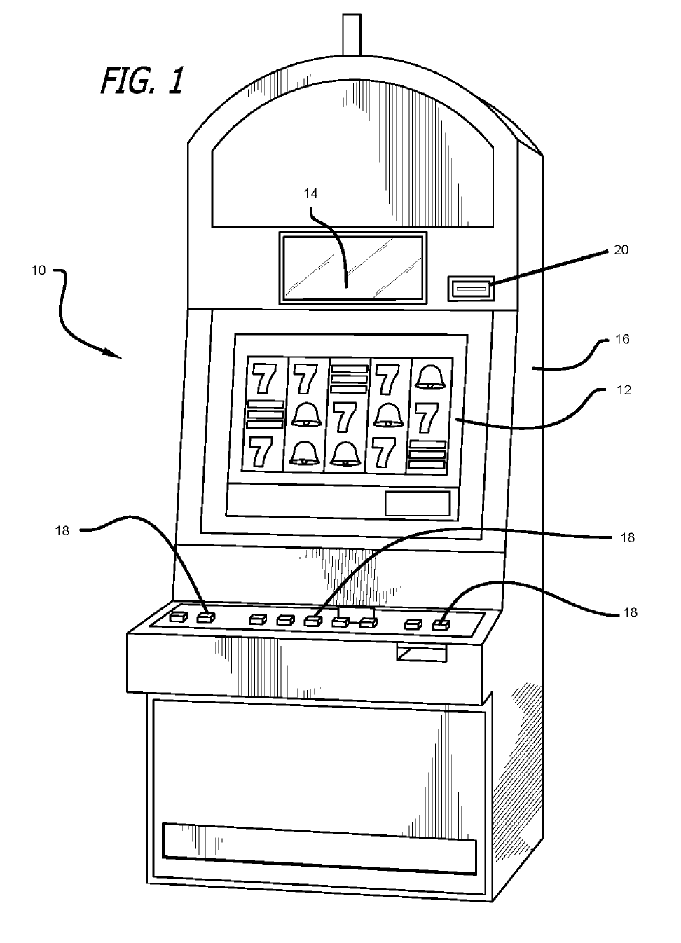

Referring now to the drawings, wherein like reference numerals denote like or corresponding parts throughout the drawings and, more particularly to FIGS. 1-3, there are shown various embodiments of a gaming machine capable of presenting a game having a multi-functional icon.

Referring now to FIG. 1, a gaming machine 10 having a game display 12 is shown. The gaming machine 10 further includes a cabinet 16 and a plurality of player-activated buttons 18. The cabinet 16 is a self-standing unit that is generally rectangular in shape. In other embodiments, the cabinet (not shown) may be a slant-top, bar-top, or tabletop style cabinet. However, any shaped cabinet may be used with any embodiment of the gaming machine 10.

The game display 12 presents one or more games of chance such as, but not limited to, mechanical slots, video slots, video poker, video blackjack, video keno, video roulette, or Class II bingo. In alternate embodiments, the game display 12 may present games of skill or games of chance involving some player skill. In various embodiments, the display 12 is a video display such as, but not limited to, a CRT (cathode ray tube), or a thin-panel display. Examples of thin-panel displays include plasma, LCD (liquid crystal display), electroluminescent, vacuum fluorescent, field emission, or any other types of thin panel displays known or developed in the art. Additionally, the game display 12 may also include a touch screen or touch glass system (not shown).

Referring again to FIG. 1, the gaming machine 10 includes a plurality of player-activated buttons 18. These buttons 18 may be used for various functions such as, but not limited to, selecting a wager denomination, selecting a number of games to be played, selecting the wager amount per game, initiating a game, or cashing out money from the gaming machine 10. While the buttons 18 shown in FIG. 1 are mechanical buttons, a touch screen system, touch pad, track ball, mouse, toggle switches, or other input means may be used to accept player input.

Generally, the gaming machine 10 also includes a game processor (not shown). The game processor is responsible for functions such as, but not limited to, managing the game, determining coin status, or dispensing player winnings. Additionally, the game processor is responsible for managing the multi-functional icon and the player's selection of a function for the icon.

As previously mentioned, the multi-functional icon has a plurality of selectable functions. The behavior or function of the multi-functional-icon is generally selected before a game is initiated. In one embodiment, the player is given the opportunity to select the function of the multi-functional icon. Alternatively, in another embodiment, the game processor may randomly select the function of the multi-functional icon. Optionally, in an alternate embodiment, the range of functions of the multi-functional icon may be based upon a player profile. That is, a player's status or player performance will “unlock” more functions of the multi-functional icon. For example, an infrequent player may only be offered two or three functions to choose from, whereas a high roller may choose from all the potential functions of the multi-function icon.

Once the function of the multi-functional icon has been selected, the player may begin playing the game with the multi-functional icon behaving according to the player's selected function for the icon. At the completion of each game, the player may reselect the function of the multi-functional icon. Alternatively, the player may maintain the function of the icon. Optionally, the player may be able maintain the function of the icon for a set number of games. For example, the player may select a particular function for five games, ten games, or any number of games.

In various types of games, the multi-functional icon may include a plurality of functions. For example, the multi-functional icon may function similar to a wild symbol, a multiplier, a bonus game trigger, a free game trigger, or any other type of game functions known to those skilled in the art.

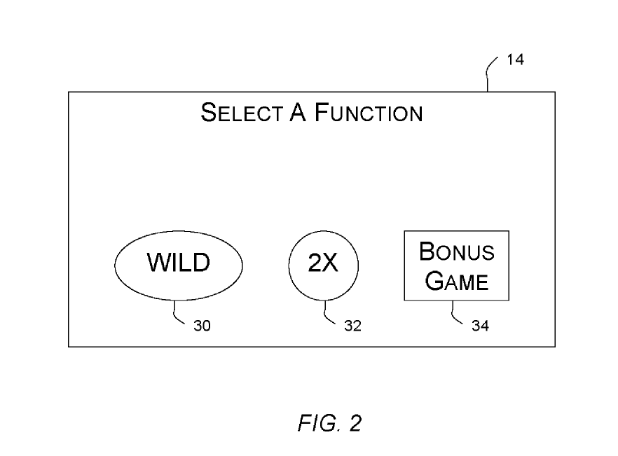

In one embodiment, each game function of the multi-functional icon is represented by a particular symbol. The symbol is a shorthand method of representing the game function of multi-functional icon. Accordingly, the player may easily associate a game function with a symbol. Furthermore, a symbol representation of the various game functions of the multi-functional icon allows the particular game function to be represented on the game display. Referring now to FIG. 2, the multi-functional icon has three game functions that are represented by three distinct symbols in the display 14. As shown in FIG. 2, the wild function is represented by a wild symbol 30. The multiplier function may be represented by a multiplier symbol 32 and the free game function may be represented by a free game symbol 34. As those skilled in the art will appreciate, the various functions of the multi-functional icon may be represented by any distinct symbol.

Generally, a wild symbol is as a symbol that can become any symbol that produces a winning outcome (i.e., a winning hand in a poker-type game or a winning symbol combination in a slots-type game). Alternatively, the multi-functional icon may be a multiplier wherein the payout of a winning outcome is multiplied by some factor (e.g., 2×, 3×, or any ×). That is, the presence of the multi-functional icon, having a multiplier function, on a payline or in a winning hand will result in a payout multiplied by some factor. Another possible function for the multi-functional icon is a bonus trigger function. That is, the presence of the multi-functional icon, having a bonus trigger function, on a payline or in a winning outcome will initiate a bonus game. Another function that may be selected is a free game function, which allows a player to win a free game if the multi-functional icon appears on the payline or in a winning outcome.

In other embodiments, the multi-functional icon may have specialized functions. For example, in one embodiment, the multi-functional icon may be a limited wild symbol. Generally, a wild symbol may become any card or symbol in the game to make a winning hand or outcome. With a limited wild symbol, the range of what the wild symbol may become is reduced to a subset of the symbols in the game. As those skilled in the art will appreciate, the subset of the symbols may be restricted or broad. For example, the limited wild symbol may only be a cherry or a bell in a slots-type game. Alternatively, the limited wild symbol may be an ace of any suit in a card-type game. Optionally, in yet another embodiment, the limited wild symbol may be only one symbol in a game (e.g., a blazing seven symbol).

In another embodiment, the multi-functional icon may have specialized functions that are particular to a game. For example, in a poker-type game, one selectable function for the multi-functional icon may be an extra draw function. The extra draw function gives the player another opportunity to hold and discard one or more of the cards in the poker hand. In a blackjack-type or poker-type game, one selectable function for the multi-functional icon may be a “second chance” function. The “second chance” function gives the player another opportunity to get a winning hand or avoid a losing hand. For example, the second chance function allows a player to draw another card (in order to get the player's hand closer to 21) or give a card back (because the player's hand has exceeded 21) in a blackjack-type game.

Additionally, in an alternative embodiment, the multi-functional icon may have a prize selection function. For example, when the multi-functional icon appears on a payline (or in a winning outcome), a player is awarded a tangible prize in lieu of, or in addition to, a cash award. The prize may be merchandise such as, but not limited to, a house, car, motorcycle, jewelry, or the like. Optionally, the prize may be services such as, but not limited to, vacations, spa packages, free hotel rooms, free meals, and/or free drinks. In another embodiment, the player may select the tangible prize that they would like to receive should the multi-functional icon appear in a winning outcome of the game.

In another embodiment, the selection of the multi-functional icon may also alter the mathematics associated with the underlying game. Accordingly, each function associated with the multi-functional icon triggers a different mathematical model. For example, the probability of achieving a jackpot in a game where the multi-functional icon is a wild function may be 0.00003% whereas the probability of same jackpot outcome may be only be 0.000024% for a game where the multi-functional icon has a free game function. In another embodiment, each function of the multi-functional icon may alter the percent payback for a game. That is, a wild function may result in a game having a 96% payback whereas a free spin function may result in a game having a 94% payback game.

In yet another embodiment, each function of the multi-functional icon may be associated with a different pay table. The pay table may be different in terms of the amount of the payout achieved for each winning outcome. For example, if a wild function is selected for the multi-functional icon, a winning outcome of cherry-cherry-wild may result in a payout of 100 credits. However, if a free game function is selected, a winning outcome of cherry-cherry-free game may only result in a payout of 50 credits. In yet another embodiment, the pay tables may differ based upon the combination of symbols required to form a winning outcome. For example, if a wild function is selected for the multi-functional icon in a video poker game, the player needs to achieve a pair of jacks or better to obtain a winning outcome. However, if a multiplier function is selected for the multi-functional icon, the play may only need to achieve a pair of tens or better.

The multi-functional icons disclosed herein may be used in various types of gaming machines. According to one embodiment, a mechanical gaming machine may include a multi-functional icon. In this embodiment, a multi-functional icon is presented on one or more mechanical reels. Because the icon on the reel cannot be physically altered when a player selects a particular function, the gaming machine includes a secondary display to show the possible functions of the multi-functional icon. Referring back to FIG. 1, the secondary display 14 is illustrated. The secondary display 14 shows the player's selected function for the multi-functional icon. In one embodiment, the secondary display 14 is a CRT or a thin-panel display, such as, but not limited to, plasma, LCD (liquid crystal display), electroluminescent, vacuum fluorescent, field emission, or any other types of thin panel displays known or developed in the art. Additionally, the secondary display 14 may also include graphics, animation, and sound to accompany the display of the multi-functional icon and/or the selected function of the icon. Additionally, the secondary display 14 may also include a touch screen or touch glass system (not shown) to allow a player to select a function of the multi-functional icon.

Alternatively, the secondary display 14 may be a backlit display glass. In this embodiment, the various functions of the multi-functional icon are presented on the display glass. When a player selects a particular function for the multi-functional icon (or the function is randomly selected by the gaming machine), the corresponding symbol on the display glass is illuminated. Alternatively, all the possible functions and corresponding symbols are illuminated and the unselected functions are darkened. In other embodiments, a touch glass system (not shown) may be positioned over the display glass or incorporated into the display glass thereby allowing the player to select the function of the icon by touching a symbol.

In a video-based gaming machine, the selected function may be shown directly on the game display 12. For example, if the game display 12 is a video depiction of a mechanical reel, the selected function for the multi-functional icon appears on the reel. That is, the image that corresponds to the selected function is shown directly on the reel. In another embodiment of a video-based gaming machine, the multi-functional icon and/or the selected function may be presented on a secondary display 14. The secondary display 14 may be a display glass or a video screen.

In another embodiment of a video-based gaming machine, the multi-functional icon and the selected function may be shown on a dedicated portion of the game display 12. That is, a portion (e.g., lower portion of the game display 12) may show the “possible functions” before the game is initiated, and the image of the selected function is shown on the game display once the game is initiated. Alternatively, a game display 12 may present a pop-up window or menu on the game display 12 before the game is initiated. Once the player selects the function of the multi-functional icon, the pop-up window may be hidden during game play.

As those skilled in the art will appreciate, various input means may be used to allow a player to select a function for the multi-functional icon. For example, the input means may be a mechanical button, touch pad, track ball, mouse, toggle switches, or a combination thereof. In those gaming machine embodiments that include video displays, a touch screen system may be provided on the screens to allow a player to select a function of the multi-functional icon.

In an optional embodiment, the gaming machine may include or is associated with a player tracking system (not shown). Referring back to FIG. 1, in one embodiment, the player tracking system (not shown) is operatively connected to a player card reader 20 located on or near the gaming machine 10. In another embodiment, the card reader 20 is capable of reading information contained on a player card and transmitting this information to the player tracking system. In another embodiment, the player tracking system 20 is a player card reader/writer that can read and write information to a player card. Information that may be read from the card includes, but is not limited to, the player's name, rating, and/or accrued points. In another embodiment, the player tracking system 20 includes biometric information including, but not limited to, fingerprints or signatures to verify the identity of the cardholder.

With a gaming machine having a player tracking system, the number of available functions for the multi-functional icon may be varied upon player performance. That is, the player data may be utilized in determining the number of “possible” functions for the multi-functional icon. Player performance may be based upon criteria such as, but not limited to, time of play, frequency of play (i.e., number of games played in a particular period of time), number of maximum bets, number of player points earned, or a combination thereof. In one embodiment, a random performance characteristic may be used to determine the range of functions that a player may select for the multi-functional icon. Alternatively, achieving a predetermined performance threshold for a particular performance characteristic may further “unlock” more functions of the multi-functional icon. For example, the gaming machine may be configured to unlock new functions for the multi-functional icon when a player has made ten maximum bets. In another embodiment, the number of functions of the icon that may be “unlocked” may be based upon the number of credits on the gaming machine. For example, $100 in credits will unlock all the functions of the multi-functional icon whereas $20 only unlocks three functions. As those skilled in the art will appreciate, one or more of any of the disclosed player performance criteria may be used to determine the number of potential functions of the multi-functional icon.

Optionally, in another embodiment, the multi-functional icon may include an audio function. For example, the game player may select a particular audio feature to play when the multi-functional icon is in use during the game.

One of ordinary skill in the art will appreciate that not all gaming machines 10 will have all these components and may have other components in addition to, or in lieu of, those components mentioned here. Furthermore, while these components are viewed and described separately, various components may be integrated into a single unit in some embodiments.

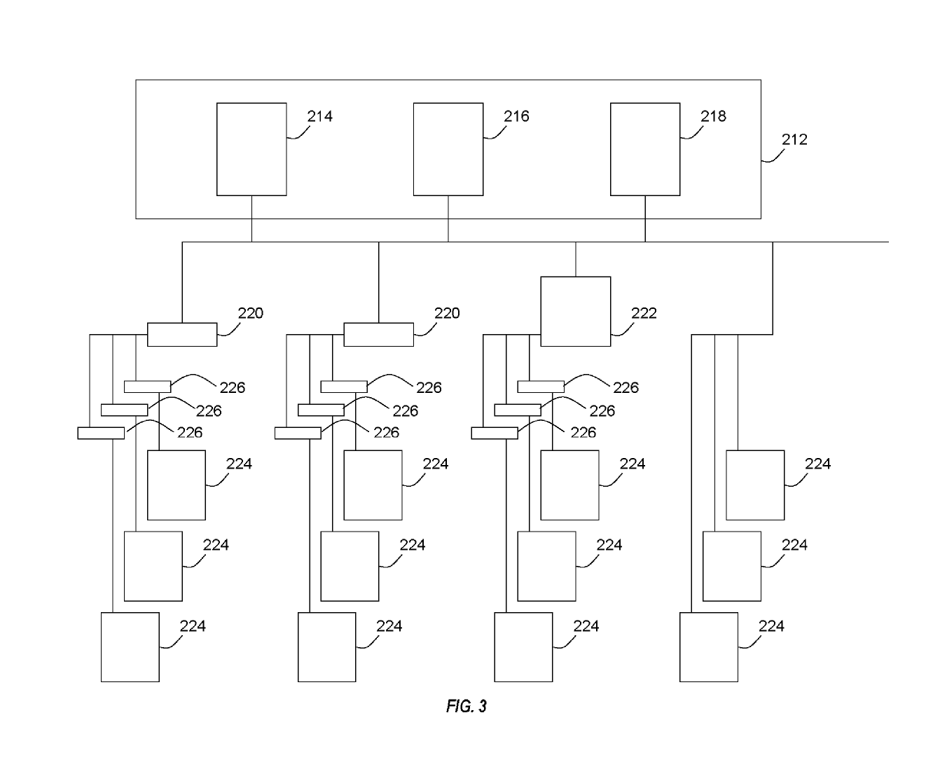

A variety of types of servers may be used as the system server 212. The type of server used is generally determined by the platform and software requirements of the gaming system. Additionally, the system server 212 may be configured to comprise multiple servers. In one embodiment, as illustrated in FIG. 3, the server system 212 is configured to include three servers. Specifically, servers 214, 216 and 218 form the server system 212, or the back-end servers. In one example, server 214 is a Windows® based server, server 216 is an IBM RS6000 based server, and server 218 is an IBM AS/400 based server. Of course, one of ordinary skill in the art will appreciate that different types of servers may also be used. The server system 212 performs several fundamental functions. For example, the server system 212 can collect data from the slot floor as communicated to it from other network components, and maintain the collected data in its database. The server system 212 may use slot floor data to generate a report used in casino operation functions. Examples of such reports include, but are not limited to, accounting reports, security reports, and usage reports. The system server 212 may also pass data to another server for other functions. Alternatively, the system server 212 may pass data stored on its database to floor hardware for interaction with a game or slot player. For example, data such as a game player's name or the amount of a ticket being redeemed at a game may be passed to the floor hardware. Additionally, the system server 212 may comprise one or more data repositories for storing data. Examples of types of data stored in the system server data repositories include, but are not limited to, information relating to individual player play data, individual game long-term accounting data, cashable ticket data, sound data including optimum audio outputs for various casino settings.

The network bridges 220 and network rack 222 shown in FIG. 3 are networking components. These networking components, which may be classified as middleware, facilitate communications between the system server 212 and the game management units 226. The network bridges 220 concentrate the many game management units 226 (2,000 on average) into a fewer number (nominally 50:1) of connections to the system server 212. Additionally, the network rack 222 may also concentrate game management units 226 into a fewer number (2000:1) of connections to the system server 212. The network bridges 220 and network rack 222 may comprise data repositories for storing network performance data. Such performance data may be based on network traffic and other network related information. Optionally, the network bridge 220 and the network rack 222 may be interchangeable components. For example, in one embodiment, a casino gaming system may comprise only network bridges and no network racks. Alternatively, in another embodiment, a casino gaming system may comprise only network racks and no network bridges. Additionally, in an alternative embodiment, a casino gaming system may comprise any combination of one or more network bridges and one or more network racks.

The gaming machines 224, illustrated in FIG. 3, act as terminals for interacting with a player playing a casino game. In various embodiments, any of the gaming machines 224 may be a mechanical reel spinning slot machine, video slot machine, video poker machine, keno machine, video blackjack machine, or a gaming machine offering one or more of the above-described games. Additionally, each gaming machine 224 may comprise one or more data repositories for storing data. Examples of information stored by the gaming machines 224 include, but are not limited to, maintenance history information, long-term play data, real-time play data and sound data. The sound data may include, but is not limited to, audio files, sound clips, wav files, mp3 files and sound files saved in various other formats. Furthermore, each gaming machine 224 comprises an audio system (not shown) for outputting sound. Typically, the audio system comprises one or more speakers, an amplifier, and access to one or more sound files.

Game management units (GMUs) connect gaming machines to network bridges. The function of the GMU is similar to the function of a network interface card connected to a desktop personal computer (PC). Referring to FIG. 3, a GMU 226 connects a gaming machine 224 to the network bridge 220. Some GMUs have much greater capability and can perform such tasks as calculating a promotional cash-back award for a player, generating a unique ID for a cash redeemable ticket, and storing limited amounts of game and transaction based data. Some GMUs may comprise one or more data repositories for storing data. The types of data stored by the GMUs may include, but is not limited to, real-time game data, communication link performance data, real-time player play data and sound data including sound files and audio clips.

In one embodiment, the GMU 226 is a separate component located outside the gaming machine. Alternatively, in another embodiment, the GMU 226 is located within the gaming machine. Optionally, in an alternative embodiment, one or more gaming machines 224 connect directly to a network bridge 220 and are not connected to a GMU 226.

Of course, one of ordinary skill in the art will appreciate that a casino gaming system may also comprise other types of components, and the above illustration is meant only as an example and not as a limitation to the types of components used in a casino gaming system.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

1. A gaming machine, comprising:
a game display for displaying one or more games;
a game processor for managing one or more games displayed on the game display, wherein at least one game includes a multi-functional icon that comprises a plurality of selectable game functions;
a means for selecting at least one game function of the multi-functional icon, wherein the selection means is in communication with the game processor.

2. The gaming machine of claim 1, wherein each game function is represented by a particular symbol.

3. The gaming machine of claim 2, wherein the particular symbol is a wild symbol, multiplier symbol, a bonus trigger symbol, free game symbol, a prize symbol, or a limited wild symbol.

4. The gaming machine of claim 1, wherein the game display is a plurality of mechanical reels.

5. The gaming machine of claim 1, wherein the game display is a video screen.

6. The gaming machine of claim 5, wherein a touch screen system is positioned over the video screen.

7. The gaming machine of claim 1, further comprising further comprising a secondary display in communication with the game processor, wherein the secondary display shows the selected function of the multi-functional icon.

8. The gaming machine of claims 7, wherein the secondary display is a cathode ray tube or a panel display.

9. The gaming machine of claims 7, wherein the secondary display is a display glass.

10. The gaming machine of claim 1, wherein the gaming machine is in communication with a system host.

11. A gaming system, comprising:
at least one gaming machine comprising a game display and a game processor providing one or more games, wherein at least one game includes a multi-functional icon comprising a plurality of selectable game functions;
a system host in communication with the gaming machines, wherein the system host monitors the gaming machines; and
a player tracking system in communication the gaming machines.

12. The gaming system of claim 11, wherein each game function is represented by a particular symbol.

13. The gaming system of claim 12, wherein the particular symbol is a wild symbol, multiplier symbol, a bonus trigger symbol, free game symbol, a prize symbol, or a limited wild symbol.

14. The gaming system of claim 11, wherein the game display is a plurality of mechanical reels.

15. The gaming machine of claim 12, wherein the game display is a video screen.

16. The gaming machine of claim 12, further comprising a secondary display in communication with the game processor, wherein the secondary display presents the selected game function of the multi-functional icon.

17. The gaming machine of claim 16, wherein the secondary display is a cathode ray tube or a panel display.

18. The gaming machine of claim 16, wherein the secondary display is a display glass.

19. A method for managing a game, the method comprising:
providing a gaming machine having a multi-functional icon, wherein the multi-functional icon comprises one or more game functions;
receiving player input selecting one or more game functions for the multi-functional icon;
setting the function of the multi-functional icon;
initiating a gaming session;
generating a game outcome; and
displaying the outcome of the game.

20. The method of claim 19, further comprising displaying the selected game function of the multi-functional icon as a particular symbol.

21. The method of claim 19, further comprising analyzing the game outcome for the multi-functional icon and ascertaining whether the selected function of the multi-functional icon produces a winning outcome.

22. The method of claim 19, further comprising awarding a prize if the outcome of the game is a winning outcome.

23. The method of claim 19, further comprising prompting a player to select the function of the multi-functional icon at the conclusion of the game.

24. The method of claim 22, wherein the prize is cash, credit, merchandise, or services.

25. A method for managing a game having a multi-functional icon, the method comprising:
receiving player input selecting a function of the multi-functional icon;
displaying the selected function of the multi-functional icon on a display screen;
initiating a gaming session;
generating a game outcome;
displaying the outcome of the game; and
analyzing the game outcome for the multi-functional icon and ascertaining whether the selected function of the multi-functional icon produces a winning outcome.

26. The method of claim 25, further comprising displaying the selected function of the multi-functional icon as a particular symbol.

27. The method of claim 25, further comprising awarding a prize if the outcome of the game is a winning outcome.

28. The method of claim 25, further comprising prompting a player to select the function of the multi-functional icon at the conclusion of the game.

29. A method for managing a game having a multi-functional icon, the method comprising:
selecting a function of the multi-functional icon;
displaying the selected function of the multi-functional icon on a display screen;
initiating a gaming session;
generating a game outcome;
displaying the outcome of the game; and
analyzing the game outcome for the multi-functional icon and ascertaining whether the selected function of the multi-functional icon produces a winning outcome.

30. The method of claim 29, further comprising prompting a player to select the function of the multi-functional icon at the conclusion of the game.

31. The method of claim 29, wherein a player selects the function of the multi-functional icon.

32. The method of claim 29, wherein a game processor selects the function of the multi-functional icon.
